(19) United States
(12) Patent Application Publication
(10) Pub. No.: US 2008/0101160 A1
(43) Pub. Date: May 1, 2008

(54) Med Alert Watch

(76) Inventor: Rodney Besson, Manchester, NH (US)

Correspondence Address: RODNEY BESSON, APT # 210, 1101 ELM STREET, MANCHESTER, NH, 03101, US

(21) Appl. No.: 11/521,539

(22) Filed: Nov. 1, 2006

(51) Int. Cl. G04B 47/00

(52) U.S. Cl. 368/12

(57) ABSTRACT

The concept of “MED-ALERT-CARRIERS” are analog/digital electronic solar powered battery operated devices like waist watch, necklace, bracelet, cell phone case med carriers, cane, blind walking cane that would offer multiple 911/EMS services within these carriers design.

When the absence, secret pass word, pass code or abnormal vital sign is detected the device would dial a medical alert service or 911.

A global positioning feature would allow the emergency medical response team to locate the wearer, even when no voice instruction have been given.

Internal pill storage and alarms including a voice or vibration alarm to remind direct and assist individual to take their medication on time.

These device could provide certain individuals a safer administration and compliance of prescription medication.

These carriers would be convenient and practical for hearing impaired individuals and those who must take prescription medication on a regular basis throughout the day.

In conclusion, the distinctive design of these carriers would allow it to be conveniently worn or carry in a stylish way providing the individual with medical care conveniences and assistance.

In this Information summary, we will review the distinctive features of the product Modification and the need it may fulfill.

These are fully digital and analog electronic rechargeable solar powered plus battery operated medical belt loop clip watches, pagers, cell phone, neck chain watches, bracelet watch, wristwatches that would offer an internal pill storage, wireless communication medical alert system with laser optical electronic or solar powered battery operated micro lenses motion detector, sensational bracelet, wireless ear plug would be adjustable to any type of conditions including mud, water, dust and shocks.

Internal well would be made with an high quality material elastic or spongy absorb type material to hold all types of meds by various sizes, external lid would be air proof seal tight.

Watch storage area would keep all types of medications at a comfortable temperature at all (time) Rubber and metal watches bracelets band would be made with a universal vice versa type material for adjustment to high and low temperatures at all times living no ring mark on the wrist or skin. On hot days watches bracelet would become cool, and on cold days watches bracelet would become warm.

An internal flexible high tech spring locate through out the bracelet would allow watch band and bracelet to alternate in a up & down shifts mode all together or, one side after another. This would allow the opening and closing of watch band/bracelet via a touch of a button or through an on screen menu.

Audible or text massages alarm capabilities designed to alert individual of the need to take his or her medication on time and correctly.

If manufactured, one or more of the “MED ALERT Watches” would feature an analog/digital flip circular electronic display centered on top of the watch's case.

The digital LCD single or double touch screen display would indicate the time, date, calendar, automatic time zone change, world clock including minutes, hour, and seconds, personal or -small text med massage reminder, enable, disable GPS-setting, Icons, Circular display Program buttons would also be located just above of the watch display screen or to the side.

The inside bracelet portion of the watch and inside the watch case would offer a high tech internal air proof well in which the medication could be stored at a cool or comfortable temperature at all time.

An analog or digital lid/hinge at the top of the analog/digital wristwatch band and watch's case display would allow access to internal well areas.

Some Digital watches would require a secure password in order to access both storage areas located inside these items.

A secret emergency release button could also be added to gain access to medications incase of any electrical malfunction.

A back up-button cell—or—lithium battery would be optional incase of a power failure within the watches system that way watch could function normally incase of an electricity or solar power failure . . . .

The belt loop clip, neck chain watch, bracelet, analog wrist watch would feature a second hand clock programmable alarm to allow the individual to set the unit to sound an alerting alarm for medication dosage at the appropriate time.

If second hand clock fail to activate, an audible tone or vibration mode could be use as back up. A small tweezers would also be evadible for grasping medication.

Tweezer would be attach to the watch or watches bracelet or partially on the inside of watch or bracelet. Medications stored inside Digital watches would be recognizable by name on digital watches screen display. A special non-toxic cleaner kit for all items would also be available to keep all items clean. If set by consumer, an alarm would sound off when ever watch or bracelet, necklace has been remove. Detected signal would be done through the pulse and temperature monitor locate at the base of these items.

Most of the digital watches, key chain, belt loop clip, neck chain, bracelet, watch clock would include a crown joystick, pen point touch screen display.

Med Alert Watches and some of its carriers menu would include, time indicator, GPS setting, GPS activation reminder, internal night light color contrast setting, LCD contrast setting, weather report, appearances and themes, add or remove programs, sound, speech, audio device, performance and maintenance.

Security settings, date, time, multiple language, and regional options, phonebook, watches menu, text map directory, calendar, automatic day time saving, alarm clock, calculator, stop watch, world clock, accessories connector, standard charger jack, USB port, PC Sync to download musical ring tone, enter patient info, enter medication info, down load audible images to use as alarms or med reminder.

The secret voice services 911-EMS quick voice dial up aide incase of an serious illness like a stroke or heart attack, body contraction movement disability, digital watches history-incoming, outgoing activities, erase-replace watch history option, messaging, small dictionary, name of meds, medications side effects.

guidance for the proper amount of meds to take via several audible images, Text massages, intonations audible alarms if recommended by consumer. The audible alarm and audible image alarm could offer pleasant images or a stern tone, musical alert tones.

A wireless earplug made for most of these items would be useful for verbally communication with EMS or 911 personnel.

It would guide/monitor individual vitals through out the day. Incase of in emergency or abnormal vital sings it would lead EMS assistant to individual or verbally communicate through a wireless earplug or via a text massaging system within the watch.

Another option would be a continuous increasing vibration signals from one level to the next coming from the watches bracelet around the individual wrist.

Within time if individual is unresponsive to neither massages a close-by local emergency personals would be on their way to locate wearer.

Consumer could also set or program watches record keeper to keep tracks of frequent-activities such as records of meds taking through out the day for example, each time med reminder alarms goes off was turned on or off a record would be kept of such activities for which and each medication removed.

Information would be kept in the watches memory bank (limited) or transferred to a personal computer via USB port. Up on consumers request base on limit, consumers watches memory bank would allow an automated med track keeper to access watches memory bank to keep track of medications/activities Under strict confidentiality agreement through the company.

Use of the “MED ALERT WATCH” and its carriers is to aid, provide EMS assistant to individuals need of help, and also to ensure that a person would take or be administered the proper amount of medication on time while out on the road or at work—not too early not too late, or not at all.

This would allow the medication to give the individual its full health benefits, aiding in a faster recovery or control of an illness.

In addition, these devices would provide certain individuals a safer administration and compliance of proscription medications.

I the inventor recommend another deluxe version similar to the rest of these items that would offer several medical alert systems within the watch design.

One would be accomplish through an internal pulse monitoring system within the base or bracelet of the watch incase of an emergency, like an abnormal or absent of pulse.

If victim were unresponsive, an EMS local team would be able to locate wearer. Second would be the voice quick dial up secret password 911-EMS device system.

Incase of an accident like a fall or an illness individuals muscles or their entire body from hand to toe becomes contracted or disable but individual is still able to communicate or speak the wireless voice quick dial up internal microphone would allow Communication between the victim and EMS personnel via a microphone wireless ear plug.

With the internal microphone stored inside the watch, bracelet, neck chain, key loop chain, a programmable voice password or number would be recognizable by an EMS 911 personnel or personal system device to assist individual.

The wireless earplug would also monitor any abnormal vital signs.

One of the systems would detect abnormal vitals. System would then send out vibrate signals to individual, audible tone, voice audible tones, sending out text or verbal questions like are you all right do you need help or assistant

### Up on consumer request a local emergency team would locate wearer.

For any abnormal vital sign up on consumers/devices request, a medical alert service or 911 personnel would verbally contact individual through the earplug.

With no voice instructions, a global positioning feature would allow the emergency medical response team to communicate and locate the wearer.

### Watches bracelet, bracelets would also take or monitor individual blood pressure.

### “MED ALERT WATCH, necklace, keychain, belt loop clip, bracelet, all could also be equip with a motion detector sensational device to guide the blind hearing impaired individuals when out on the road or at home.

Home guidance for the blind or hearing impaired could be set to monitor and guide individuals via a home wireless med alert audible system that would come with one or more of these items up on consumer's request.

A sensational audible laser optical micro lenses devices installed inside or on the surface of all items would help guide individuals to locate program buttons on all items listed.

Verbal communication via the head-set, soft ware or text written direction on watch's screen display would help direct all individuals on how to put and remove medication inside these items.

The audible laser optical micro lenses or motion detector being place on most of these items including watch's display or around the watches bracelet would allow blind individual & hearing-impaired users to travel independently and safely.

The watches laser optical micro lenses or motion detector would communicate with individual verbally via a wireless earplug or through text, audible tones or vibration mode.

The laser Optical micro lenses motion detector would provide an advance warning ahead of time of a clear path for safe travel and detects obstacles like automobiles, humans, animals, bicycle, bikes, motor cycles, street signs, stairs, street corners, incoming traffic, stop signs, law enforcement, 911 EMS badge number by name and distance in the travel path at all angles.

Individual or company could set this advance-warning feature by them self or through the company. There is no limit to where the “MED ALERT WATCH” and all these items can be used.

All items would be waterproof, dust proof, unbreakable, stainless, and scratch free, (three option) rechargeable battery, electric, solar power operated, a USB and standard charger cradle would also be available.

On consumers request bracelet would come with similar features as the “MED ALERT WATCH.”

Audible laser optical micro lenses motion detector around the bracelet equip with a wireless ear plug that would notified and aide/guide individuals at all angles by naming who in what as an obstacle or object approaches individual by feet or yard ahead of time via a wireless ear plug system device.

The appealing features of “MED ALERT WATCH” and all its carriers would be the attractive design, ease of use, and the healthful benefits such devices could provide.

The “MED ALERT WATCH” and its carriers could be set and used in much the same manner as other analog/digital watches with alarms.

In addition, the medical emphasis of the product would make it ideal for alerting an individual to take his or her medication, guidance, EMS assistant, thus reducing the opportunity for medical errors while increasing medication compliance.

This practical product would assure improved control over the administration of medication and reduce the risk of most harmful incidents.

This would be crucial since a large portion of the population that takes prescriptions and are at risk to fall or experience any physical illness is elderly, critically ill, hearing impaired, blind, and/or handicapped.

The bracelet, neck chain, key chain would also be crucial monitoring kids and adults through out the night and day.

The “MED ALERT WATCH” and its carriers would be convenient and practical for impaired and non-impaired individuals who must take proscription medications on a regular basis.

The distinctive design of the “MED ALERT WATCH” Would allow it to be conveniently worn as a stylish timepiece yet would provide the individual with medical care conveniences and assistance.

The GPS monitoring of individuals would only be enable or disable by consumers request only.

When an abnormal or absent of vitals sign, faller of speech or when your text or verbal speech secret pass word has been detected by the carriers 911 EMS and GPS system, it would automatically activate the carriers 911 EMS full code even if such feature was disable by individual. The monitoring of individual and vitals would be monitored by 911 OR EMS personal to aide and locate wearer.

Users could enjoy greater medication compliance, thereby ensuring a more effective recovery and reduced risk of complication and errors.

Additionally, this product would be reliable and affordable to all.

Features offered with the “MED ALERT WATCH” and all its carriers would include various alarm options, including, visual tone images, voice options tones, vibration-alerting mode, weather report, optical laser lenses or motion detector to read and identify objects or obstacles by name and distance.

Incase of any disability health risks like a stroke, seizer, high blood pressure, low blood pressure, abnormal heart beat, abnormal pulse, high temp, low temp the “MED ALERT WATCH”/devices would offer several medical alerts and assistant incorporated within alerting others or emergency personnel when the victim is unable to speak or act for her or himself.

An electrical, solar power, battery operated hand sensational med carrier detachable bracelet, necklace, neck chain, to direct/aide the blind impaired person verbally via a audible wireless system aiding individual to where watch is, parts, how to assemble watch or take apart. Once watch or items have been assembling an audible voice then lets individual set up medication inside item or inside the watch bracelet.

Audible alarms or hand guide motion sensational device would assist impaired ones. The laser optical lenses bracelet, necklace, neck chain would provides verbally, text massaging assistant to hearing impaired/blind individual by naming objects, food & liquids nutrition, size's, color of who and what types of object as objects approaches from a distance ahead of time.

I the inventor also recommend the offering an extra deluxe Version incorporates with a medic alert feature within the watch systems.

The monitor of vitals would include measure of the pulse rate, temperature and blood pressure monitor locate through out watches bracelet or separately could also be optional.

A high tech audible software alarm system could also be available by alerting others around the victim also by incorporating with the subways trains, buses and, cruise boats medic personal.

The “MED ALERT WATCH” would be produced using the same materials and technologies utilized in the production of conventional personal alarm watches for all including the hearing impaired/blind. A special metal by type adjustable to all types of temperatures to keep individuals wrist at normal comfort, the same saying for watch internal well.

The case of the watch would be colored stamped from gold-plated metal, gold, or austenitic stainless steel, or silver platinum.

The watches crystal, button cell or lithium battery, solar powered, electrical, rechargeable, and the desired watchband(s) would be available as part for final assembly.

In addition to the multiple settings, the bracelet and watches unit including all items would include an automatic internal night light.

Items could be made of very highly light metal, plastic comfort protection to all types of weather temperatures conditions.

The band of watch would be fully adjustable for size.

The digital/analog clockworks, integrated circuits, small liquid crystal display (LCD), and audible alarm assembly would likely be standard components as well, available for standard watch manufacturing adapted to the specific design requirements of the “MED ALERT WATCH/products.”

All or a portion of the band would include an internal well or an elastic spongy absorb type material that would store a small supply of medications in pill form. An analog or digital electric hinged lid would permit access to the well.

By the press of a button or code, you could lock and unlock watches bracelet as it rotate in a 30/90 degree angle.

Equip with a secret safety release button incase of any power failure.

Safety release button would permit access to internal wells.

Another option for those owning the “MED ALERT WATCH” would be a sing language software/hardware home monitoring device accompanied with the watch for hearing impaired.

Individual would be able to receive and send out massages to emergency medical personals in a sing language format through a digital laser optical motion detector lenses screen display.

### DESCRIPTION: PRODUCT CONCEPT REVIEW

In this information summary, we review the distinctive device features of the product modification and the need it may fulfill.

The concept of “MED ALERT WATCH” is an analog digital wristwatch that would offer internal pill storage and audible alarm capabilities designed to alert an individual of the need to take his medication.

If manufactured, the “MED ALERT WATCH” would feature a large, flip circular electronic display centered in the watch face.

This LCD display would indicate the time, including hour, minutes, and seconds. Program buttons would be located just above or to the side of the display screen.

The bracelet portion of the watch would offer an internal well in which the medications could be stored. A hinge at the band would allow this area to be accessed.

This well would contain necessary medications required for the day.

The watch would feature a programmable alarm that would allow the individual to set the unit to sound an alert for each medication dosage.

At the appropriate hour, the alarm would activate for the dose to be taken. The clock display would indicate the time.

The alarm would activate until the individual resets the unit. I the inventor recommend the use of voice alarms as well, with a variety of intonations to be selected by the consumer.

For example, the voice alarm could offer a pleasant tone, stern tone, musical tones, and the like. In addition, a vibration alarm could be offered.

Use of the “MED ALERT WATCH” would aid in ensuring that a person would take or be administered the proper amount of medication and on time—not too early, not too late, or not at all.

This would allow the medication to give the individual its full health benefits, aiding in a faster recovery or control of an illness

In addition, this device could provide certain individuals a safer administration and compliance of proscription medications.

In addition, I recommend a deluxe version that would offer a medical alert system within the watch design . . . .

This would be accomplishing through an internal pulse monitor within the base or bracelet of the watch.

When the absence of pulse is detected, the device would dial a medical alert service or 911.

A global positioning feature would allow the emergency medical response team to locate the wearer, even when no voice instructions have been given.

### Function and Appealing Features

Mr. Rodney Besson is suggesting “MED ALERT WATCH” because I believe it would fulfill the need for a watch that alert the wearer to the time by sounding a pre-programmed, audible alarm, indicating the need to take his or her medication.

The medications would be conveniently stored within the band of the watch . . . .

The appealing features of “MED ALERT WATCH” and its carriers would be its attractive design, ease of use, and the healthful benefits such a device could provide.

The “MED ALERT WATCH” could be set and used in much the same manner as other analog/digital watches with alarms.

In addition, the medical emphasis of the product would make it ideal for alerting an individual to take his medication, thus reducing the opportunity for medical errors while increasing medication compliance.

This practical product would assure improved control over the administration if medication.

This would be crucial since a large portion of the population that takes prescription is elderly, critically ill, and/or handicapped.

The “MED ALERT WATCH” would be convenient and practical for individuals who must take prescription medications on a regular basis throughout the day.

The distinctive design of the “MED ALERT WATCH” and all its carriers would allow it to be conveniently worn as a stylish timepiece yet would provide the individual with medical care conveniences and assistance.

Users could enjoy greater medication compliance, thereby ensuring a more effective recovery and reduced risk of complications and errors.

Additionally, this product would be reliable and affordable.

Features offered with the “MED ALERT WATCH” would include various alarm options, including voice options and vibration alerts, secret text or verbal 911 EMS dial up signal incase of an emergency.

Lastly, a deluxe version of the “MED ALERT WATCH” would offer a medic alert system incorporated within, alerting others around the victim or emergency personnel when the victim is unable to speak or act for himself.

1. I MR. Rodney Besson is putting in a claim for all items listed in the utility pattern application Ser. No. 11/521,539
